(19) United States
(12) Patent Application Publication
(10) Pub. No.: US 2006/0109437 A1
(43) Pub. Date: May 25, 2006

(54) Photolithography system including control system to control photolithography apparatus and method of controlling the same

(76) Inventor: Ki-Ho Kang, Hwaseong-gun (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/229,684

(22) Filed: Sep. 20, 2005

(30) Foreign Application Priority Data
Sep. 21, 2004 (KR) 2004-75666

(51) Int. Cl. G03B 27/68

(52) U.S. Cl. 355/52; 356/400

(57) ABSTRACT

A photolithography system includes a photolithography apparatus adapted to perform a photolithography process on a wafer; and a control system adapted to control the photolithography apparatus. The control system includes a measurement unit adapted to measure one or more characteristics of a feature formed on the wafer by the photolithography process and to generate therefrom measured data, and a first server adapted to store a destination address where the measured data may be remotely accessed, and adapted to transmit the measured data to the destination address via a network connection. The destination address may be an e-mail address, in which case the first server transmits the measured data in an e-mail message accessible at a destination terminal connected to the network.

### BACKGROUND AND SUMMARY OF THE INVENTION

1. Field of the Invention

The present invention generally relates to a photolithography system, a control system to control a photolithography apparatus to manufacture a semiconductor device, and a method of controlling the same. More particularly, the present invention relates to a photolithography system and a control system to control a photolithography apparatus by generating wafer measurement data, and a method of controlling the same.

A claim of priority is made to Korean Patent Application No. 2004-75666, filed on 21 Sep. 2004, the entirety of which is hereby incorporated herein for all purposes as if fully set forth herein.

2. Description of Related Art

A photolithography apparatus used to manufacture a semiconductor device generally includes a spin coater to coat a photoresist onto a wafer, an exposure unit to expose the coated photoresist, a development unit to develop the exposed photoresist, and a baking unit to bake the photoresist.

The exposure unit generally includes: an illumination system having a light source and illumination optics; a reticle; a reticle stage for supporting the reticle; a projection optical system; a wafer stage for supporting a wafer; and an exposure unit controller for controlling the aforementioned elements of the exposure unit. Operationally, light from the illumination system illuminates the reticle, and the projection optical for projects light output from the reticle onto a wafer.

A control system for the photolithography apparatus includes: a line width measurement unit to measure the line widths of patterns formed on a wafer by the exposure and development processes, using a scanning electron microscope (SEM); and an alignment measurement unit to measure the overlay alignment of the patterns. In addition, a data server is also provided to store measured data and to allow an operator to manage the stored data as desired.

An alteration of the consistent reproduction of patterns formed during a photolithography process may occur due to changes in operating conditions in the exposure unit or due to internal errors in the system. Such an alteration may occur when one or more parts are replaced, or during system setup. Such an alteration may affect the line widths and/or overlay alignment of the patterns illuminated through the reticle of the exposure unit.

When such an alteration occurs, separation and sampling processes for the corresponding photolithography apparatus are performed before proceeding to the next process step. The line widths and the overlay alignment are measured with a line width measurement unit and alignment measurement unit, respectively. The measured results are compared with predetermined tolerances. Then, subsequent processes are performed only when the measurement results show no abnormality.

If an alteration occurs, an operator must continuously monitor and manage pattern line widths or overlay alignment trends through a data server to minimize the errors to guarantee reliable semiconductor devices.

The monitoring and management includes tracking the cause of the alterations, i.e., collecting history data of wafers input to the exposure unit and comparing it with the results stored in the data server after the exposure process. The wafer history includes wafer states, fabrication recipes and compensation data.

However, such a monitoring process generally requires manual operations. Therefore, when manual monitoring is required, an operator must manually enter a retrieve condition into a data server to retrieve the necessary data, and then use a separate program to process the data. Therefore, such a monitoring system and method can be cumbersome.

Accordingly, it would be desirable to provide an improved system and method for controlling photolithography equipments for manufacturing a semiconductor device which does not require such intensive manual operations.

In one aspect of the invention, a photolithography system comprises: a photolithography apparatus adapted to perform a photolithography process on a wafer; and a control system adapted to control the photolithography apparatus, the control system including: a measurement unit adapted to measure one or more characteristics of a feature formed on the wafer by the photolithography process and to generate therefrom measured data; a first server adapted to store a destination address where the measured data may be remotely accessed, and adapted to transmit the measured data to the destination address via a network connection.

In another aspect of the invention, a method of operating a photolithography system, comprises: setting a destination address where measured data is to be transmitted; setting a condition upon the satisfaction of which the measured data is to be transmitted to the destination address; performing a photolithography process on a wafer; measuring one or more characteristics of a feature formed on the wafer by the photolithography process to generate the measured data; and transmitting the measured data to the destination address where the measured data may be accessed remotely from the photolithography system.

In still another aspect of the invention, a control system adapted to control one or more photolithography apparatus, the control system comprises: means for setting a destination address where measured data is to be transmitted and where the measured data may be remotely accessed; means for setting a condition upon the satisfaction of which the measured data is to be transmitted to the destination address; a measurement unit adapted to measure one or more characteristics of a feature formed on the wafer by the photolithography process and to generate therefrom the measured data; and a first server adapted to transmit the measured data to the destination address via a network connection

### BRIEF DESCRIPTION OF THE DRAWINGS

The above and other aspects of the present invention will become more apparent by the description of the detail exemplary embodiments of the present invention with reference to the attached drawings in which:

FIG. 1 is a block diagram illustrating a photolithography system including a plurality of photolithography apparatuses, and a control system to control the photolithography apparatuses;

FIG. 2 is a flowchart illustrating operations of the control system of FIG. 1;

FIG. 3 is a flowchart illustrating a process of transmitting data from a communication server of the control system of FIG. 1; and

FIG. 4 is a flowchart illustrating a process of monitoring a transmission condition in a communication server for the control system of FIG. 1.

### DETAILED DESCRIPTION OF THE INVENTION

Hereinafter, exemplary embodiments according to the present invention will be described in detail with reference to the accompanying drawings. The present invention may, however, be embodied in many different forms and should not be construed as being limited to the embodiments set forth herein; rather, these embodiments are provided as working examples.

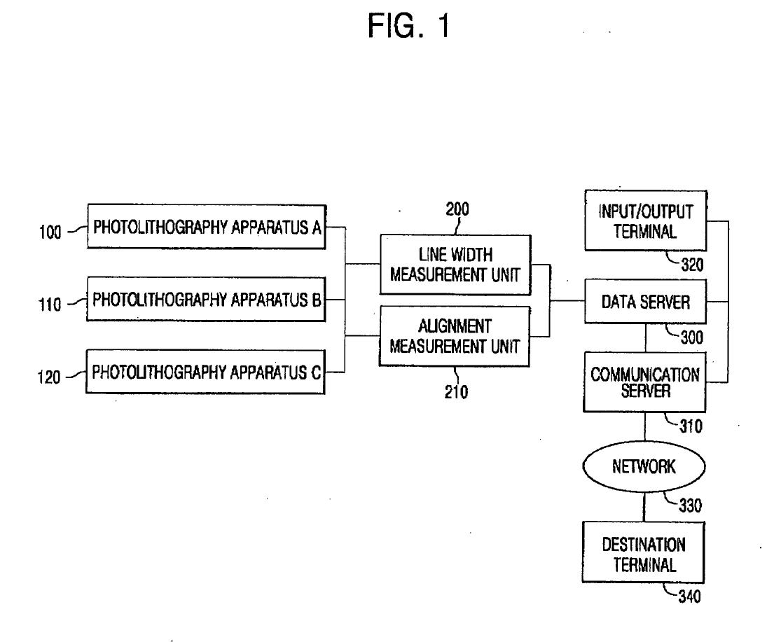

FIG. 1 illustrates a photolithography system for manufacturing semiconductor devices. The photolithography system includes a plurality of photolithography apparatuses 100, 110, and 120. The number of the photolithography apparatus may vary according to needs and conditions.

Although not illustrated in the drawings, each photolithography apparatus include the units and systems as detailed in the background section above, including a spin coater for coating a photoresist on a wafer, an exposure unit, a development unit, and a baking unit, etc. Furthermore, each exposure unit generally includes: an illumination system having a light source and illumination optics; a reticle; a reticle stage for supporting the reticle; a projection optical system; a wafer stage for supporting a wafer; and an exposure unit controller for controlling the aforementioned elements of the exposure unit. Operationally, light from the illumination system illuminates the reticle, and the projection optical for projects light output from the reticle onto a wafer.

The photolithography system of FIG. 1 also includes measurement units to measure widths of patterns formed on a wafer by a photolithography process. The measurement units include a line width measurement unit 200 to measure line width of the patterns formed on the wafer, and an overlay alignment measurement unit 210 to measure the overlay alignment of the patterns.

Line width measurement unit 200 generally includes a critical dimension scanning electronic beam microscope (CD SEM) used to examine whether the line width of a pattern meets specified requirements.

Overlay alignment measurement unit 210 is used to examine the positional relationship between a pattern formed by a previous photolithography process and a pattern formed by a current photolithography process. Many types of line width measurement units 200 and overlay alignment measurement units 210 are manufactured by different manufacturers, and the photolithography system is not limited to a specific type.

The photolithography system of FIG. 1 further includes one or more servers to store measured data measured by line width measurement unit 200 and overlay alignment measurement unit 210, and also to store wafer history data. The server(s) also are configured to automatically forward, i.e., transmit, the measured data to a registered receiver.

Specifically, a data server 300 is provided to store the measured data, and a communication server 310 is provided to transmit stored data to a destination terminal 340, for example, via an e-mail message. Data server 300 is often called a trend control system. Communication server 310 is connected with destination terminal 340, for example, via wired and/or wireless networks.

The wired networks may include a local area network (LAN), a wide area network (WAN), etc. Destination terminal 340 may comprise a mobile computer, a desk top computer, a personal digital assistant (PDA), and/or other mobile communication devices.

The servers are classified into data server 300 and communication server 310, based on their functionalities. However, these functions may be physically integrated into a single server, or physically separate servers. If a single server is used, the single server preferably further includes a data input unit, a data output unit, a data storage unit, a data processing unit, and a network interface, in addition to an input/output terminal 320. Input/output terminal 320 may include a keyboard, a pointing device such as a mouse, a display screen, floppy disk, a memory card or module, etc.

Data server 300 selects one of photolithography apparatuses 100, 110, and 120, and sorts measured data from the selected photolithography apparatus. Data server 300 stores the measured data, and processes the data to be transmitted to communication server 310. Beneficially, data server 300 converts the measured data into a predetermined transmission format before transmitting the formatted data to the communication server 310.

Hereinafter, an exemplary operation will be described with reference to photolithography apparatus 100. It will be understood that the same operation may be preformed with respect to photolithography apparatuses 110 and 120.

Processing of data is performed based on processing conditions input by an operator through input/output terminal 320 connected to data server 300. Data server 300 stores a working history of wafers that have been processed, and updates the history when it receives data on a wafer that is currently being processed. The history includes the state of a wafer, fabrication recipes, and compensation data generated while the wafers are processed.

Communication server 310 transmits the data to destination terminal 340 based on a predetermined transmission condition. The transmission condition may include, for example, a receiver's e-mail address, a transmission time, a transmission interval, and upper and lower acceptable limits of measured data. The transmission condition is preferably input by an operator into communication server 310. Beneficially, communication server 310 transmits data in a predetermined transmission format after the data has been processed by data server 300.

The registration of the transmission condition may be performed in such a manner that an administrator accesses communication server 310 through input/output terminal 320, opens a page to set-up an automatic e-mail registration and enters the receiver's e-mail address into a predetermined format. Then, the administrator enters the other forwarding conditions, and operates a registration switch provided on input/output terminal 320.

Communication server 310 automatically transmits the data, for example to the registered e-mail address, over a communication network when the aforementioned transmission condition occurs.

Communication server 310 is connected with data server 300 to constantly monitor the measured data stored in data server 300, and automatically transmits the measured data to destination terminal 340 when the measured data exceeds acceptable upper or lower limits.

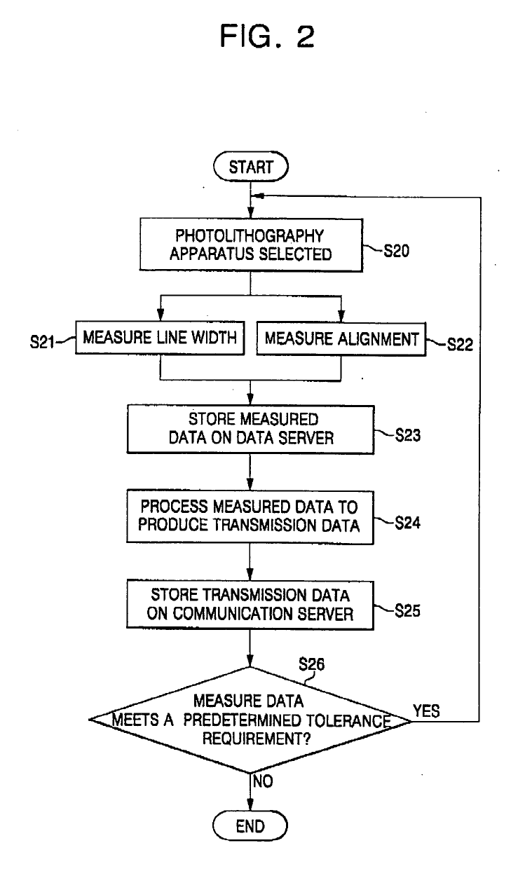

Next, a method of controlling photolithography apparatuses for manufacturing a semiconductor device will be described with respect to FIG. 2.

Referring to FIG. 2, while a wafer exposure process is performed in photolithography apparatuses 100, 110, 120, respectively (S20), one of the photolithography equipments 100, 110, 120 having an alteration is selected as a monitoring target. Such an alteration may occur when one or more parts are replaced, or during system setup in one of the lithography apparatuses (e.g., 100). Such an alteration may affect the line widths and/or overlay alignment of the patterns illuminated through the reticle of the exposure unit

In other words, the monitoring target is selected by performing segmentation and sampling for a wafer and then measuring the line widths and the alignment by using the line width measurement unit 200 and the alignment measurement unit 210 to examine any abnormality in the pattern which may occur when an alteration occurs in one of the lithography apparatuses.

When a photolithography process is performed on a wafer in the target being monitored (e.g., photolithography apparatus 100), line width measurement unit 200 measures line widths of the wafer (S21), and an overlay alignment measurement unit 210 measures overlay alignment of the wafer (S22). Then, the measured data are automatically sent to and stored in a data server 300 (S23).

Data server 300 also processes the stored data to convert it to transmission data having a transmission data format (S24). The transmission data format may have been previously input into data server 300 by an operator through an input/output terminal 320. In other words, data server 300 separately creates the transmission data after storing the measured data. The transmission data is then stored, beneficially in communication server 310 (S25).

A separate control function may be provided for line width measurement unit 200 and alignment measurement unit 210. Therefore, if the measured data does not satisfy predetermined acceptance conditions, photolithography apparatus 100 determines that a problem exists with a photoresist pattern on the wafer. In that case, the patterned photoresist is stripped from the wafer. After removing the patterned photoresist, photolithography apparatus 100 cleans the wafer and performs a new photoresist coating, alignment exposure, and development processes after realigning the wafer stage and the reticle stage in an attempt to achieve an accurate wafer alignment. The control system may again perform the measurements, or it may issue an interlock fault when it is not possible to do subsequent workings.

If the predetermined acceptance conditions are satisfied, photolithography equipment 100 performs a photolithography process on a new wafer, and the aforementioned processes to measure the line widths and the alignment and storing the measured data are repeated.

Communication server 310, which has the transmission condition(s), transmits the transmission data stored therein whenever the transmission condition(s) are satisfied.

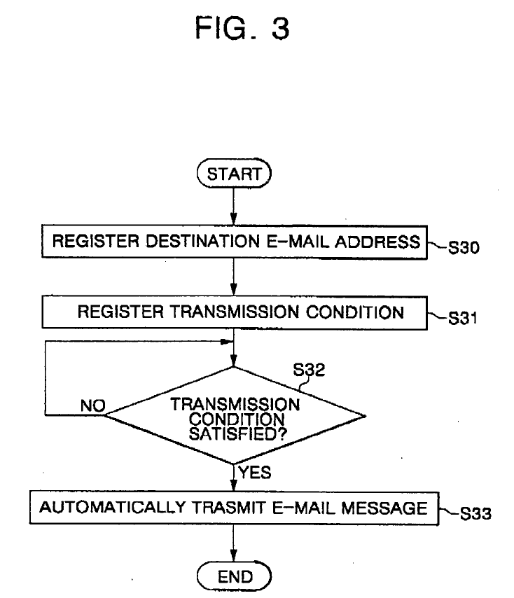

Referring to FIG. 3, a receiver's e-mail address is registered (S30) and the transmission condition(s) for the transmission data are also registered (S31). The transmission data is transmitted to a destination terminal 340 (S33) only if the transmission condition(s) occur (S32).

The transmission condition(s) can be set by registering the destination e-mail address, a receipt period, a receipt interval, and acceptable ranges of the measured data. In explanation, a monitoring period of a predetermined length is typically established for the corresponding exposure unit of the photolithography equipment 100 in which an alteration has occurred. Therefore, it is necessary to register the monitoring period for the monitoring target 100 and periodically to receive the measured data during the monitoring period.

If the measured data is within the acceptable range, it is determined that the photolithography process can be normally processed. However, if the measured data exceeds the acceptable range, the corresponding photolithography will result in errors.

In other words, even when the corresponding photolithography equipment 100 performs the alignment and exposure processes, it will experience process errors because its wafer patterns can not be appropriately formed. In this case, an operator is required to promptly manage such an error situation.

As illustrated in FIG. 3, if the transmission condition has been registered and the transmission data is input from data server 300 to communication server 310 after the photolithography process, communication server 310 continuously monitors whether or not the transmission data satisfies the transmission condition(s) (S32). If the transmission data satisfies the transmission condition(s), communication server 310 automatically transmits the transmission data to destination terminal 340 (S33).

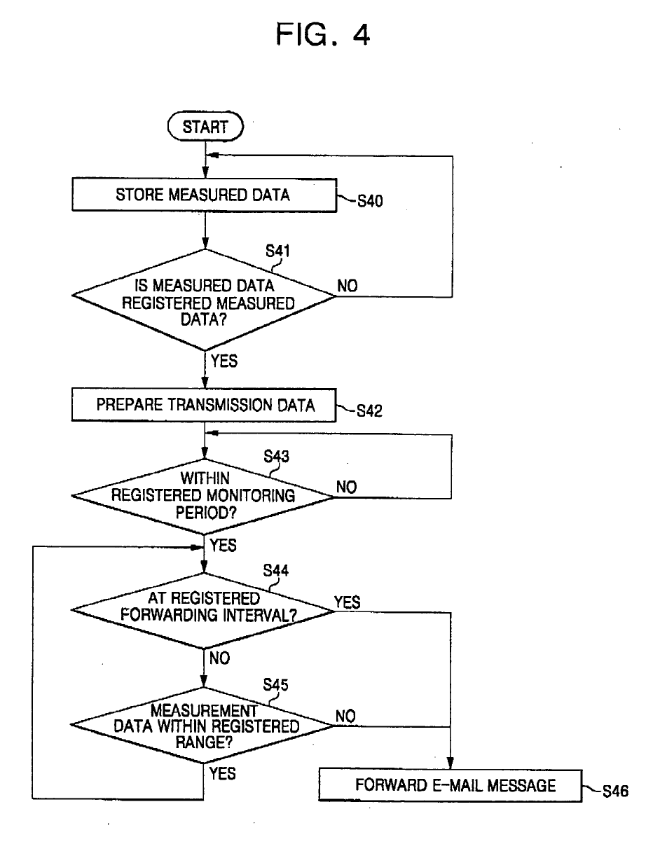

A process of monitoring the transmission condition(s) is shown in FIG. 4. More specifically, when the measured data is generated and input (S40), data server 300 determines whether or not the measured data corresponds to registered measured data (S41). If the measured data corresponds to registered measured data, data server 300 processes the measured data to produce transmission data according to a predetermined transmission format (S42). Otherwise, data server 300 continuously monitors the measured data (S41).

When the processing of the transmission data is complete, communication server 310 determines whether or not the measured data was measured within a registered monitoring period (S43). If communication server 310 determines that the measured data was measured within the registered monitoring period, it proceeds with subsequent processes. Otherwise, communication server 310 discards the transmission data and continuously monitors the measured data until the registered monitoring period occurs.

The reason for monitoring whether or not the data was measured within a registered monitoring period is to back up the transmission data when an operator erroneously establishes the monitoring period or the monitoring period requires additional time. Of course, in this case, the measured data has been stored in data server 300. However, if an operator establishes the monitoring period again while the transmission data is backed up, it would be possible to recognize the entire wafer history trends more accurately by using the backed up data.

If it is determined that the measured data has been measured within the monitoring period, communication server 310 determines whether or not the transmission data is being supplied at a registered transmission interval (S44). That is, the measured data is not transmitted every time the measured data is input, but is transmitted when a registered transmission interval is reached. The transmission interval is previously entered by an operator. If it is determined that the registered transmission interval has not occurred, communication server 310 proceeds to step (S45) as discussed below, and then continuously monitors the transmission data until the registered transmission interval time is reached. Once the registered transmission interval is reached, communication server 310 immediately transmits the transmission data to destination terminal 340 corresponding to the registered receiver's e-mail address (S46).

After determining whether or not the transmission data is at the transmission interval, communication server 310 determines whether or not the measured data is within the predetermined acceptable range (S45). If the measured data is not within the predetermined acceptable range, it means that an error has occurred in photolithography apparatus 100 and the exposure in the photolithography equipment 100 is not appropriately processed according to the established recipe. This may occur when a significant alternation is made, or when another operator changes the recipe of the photolithography equipment 100 without permission. In this case, a notification e-mail is immediately forwarded to the destination terminal 340 corresponding to the registered e-mail address (S46), regardless of whether or not the registered forwarding interval has occurred, to allow the operator to address the situation without delay when an error occurs in the exposure unit of photolithography apparatus 100.

Beneficially, when an alteration occurs in the exposure unit of photolithography apparatus 100, wafer history trends such as line widths or overlay alignment status in photolithography apparatus 100 are forwarded to an operator through an e-mail message at an interval registered by the operator. Therefore, an operator can periodically monitor the wafer history trends of photolithography apparatus 100 experiencing the error, and can easily manage the error. In addition, it is possible to immediately address the situation when the measured data exceeds an acceptable range.

While the present invention has been particularly shown and described with reference to exemplary embodiments thereof, it will be understood by those skilled in the art that various changes in form and details may be made therein without departing from the scope of the present invention.

What is claimed is:

1. A photolithography system, comprising:
a photolithography apparatus adapted to perform a photolithography process on a wafer; and
a control system adapted to control the photolithography apparatus, the control system including:
a measurement unit adapted to measure one or more characteristics of a feature formed on the wafer by the photolithography process and to generate therefrom measured data;
a first server adapted to store a destination address where the measured data may be remotely accessed, and adapted to transmit the measured data to the destination address via a network connection.

2. The system of claim 1, where the first server includes a data storage unit adapted to store the measured data.

3. The system of claim 1, further comprising a second server operatively connected to the first server and adapted to store the measured data.

4. The system according to claim 2, further comprising an input/output terminal connected to the server, wherein an operator inputs process conditions for the photolithography apparatus.

5. The system of claim 1, where the measurement unit comprises a line width measurement unit and an overlay alignment unit.

6. The system of claim 1, wherein the control system further comprises means for setting the destination address.

7. The system of claim 1, where the destination address is an e-mail address and the first server transmits the measured data in an e-mail message accessible at a destination terminal connected to the network.

8. The system of claim 1, further comprising a second photolithography apparatus, wherein the control system is also adapted to control the second photolithography apparatus.

9. The system of claim 1, further comprising means for supplying a transmission condition, wherein the first server is adapted to transmit the measured data to the destination address only when the transmission condition is satisfied.

10. A method of operating a photolithography system, comprising:
setting a destination address where measured data is to be transmitted;
setting a condition upon the satisfaction of which the measured data is to be transmitted to the destination address;
performing a photolithography process on a wafer;
measuring one or more characteristics of a feature formed on the wafer by the photolithography process to generate the measured data; and
transmitting the measured data to the destination address where the measured data may be accessed remotely from the photolithography system.

11. The method of claim 10, further comprising storing the measured data in a server of the photolithography system.

12. The method of claim 10, wherein measuring one or more characteristics of a feature formed on the wafer includes:
measuring a width of a line pattern formed on the wafer; and
measuring an overlay alignment of alignment patterns formed on the wafer.

13. The method of claim 10, further comprising processing the measured data according to a set transmission format before transmitting the measured data.

14. The method of claim 10, wherein setting a condition upon the satisfaction of which the measured data is to be transmitted to the destination address includes setting an acceptable range for the measured data.

15. The method of claim 10, wherein setting a condition upon the satisfaction of which the measured data is to be transmitted to the destination address includes setting a monitoring period for the measured data and setting a transmission interval during which the measured data is to be transmitted.

16. A control system adapted to control one or more photolithography apparatus, the control system comprising:
means for setting a destination address where measured data is to be transmitted and where the measured data may be remotely accessed;
means for setting a condition upon the satisfaction of which the measured data is to be transmitted to the destination address;
a measurement unit adapted to measure one or more characteristics of a feature formed on the wafer by the photolithography process and to generate therefrom the measured data;
a first server adapted to transmit the measured data to the destination address via a network connection

17. The system of claim 16, where the means for setting a destination address and the means for setting a condition includes a keyboard.

18. The system of claim 16, where the means for setting a destination address and the means for setting a condition includes a pointing device.

19. The system of claim 16, where the measurement unit comprises a line width measurement unit and an overlay alignment unit.

20. The system of claim 16, further comprising a second server operatively connected to the first server and adapted to store the measured data.
